(19) United States
(12) Patent Application Publication
(10) Pub. No.: US 2020/0319805 A1
(43) Pub. Date: Oct. 8, 2020

(54) Method for Writing Non-Volatile Memory of System-on-Chip

(71) Applicant: Yinghwi CHANG, New Taipei City (TW)

(72) Inventor: Yinghwi CHANG, New Taipei City (TW)

(21) Appl. No.: 16/372,438

(22) Filed: Apr. 2, 2019

(51) Int. Cl. G06F 3/06; G06F 7/58

(52) U.S. Cl. CPC G06F 3/0623; G06F 7/58; G06F 3/0679; G06F 3/0659

(57) ABSTRACT

A method for writing non-volatile memory of System-on-Chip comprises (a) inputting a write address signal into a write address logical device; (b) determining the write address signal as a relative low value or a relative high value of a specific address range, to generate a selection code signal; (c) inputting the selection code signal into a multiplexer; (d) inputting random number signal created by a random number generator into the multiplexer; and (f) inputting the random number signal into the non-volatile memory to write into the specific address range of the nonvolatile memory.

### TECHNICAL FIELD

The present invention relates to System-on-Chip (SoC), and more particularly a method for preventing non-volatile memory of System-on-Chip from being copied.

### BACKGROUND

Non-volatile memory integrated in System on Chip (SoC) can store programs or data, which can still be stored in non-volatile memory after power off, and the System on Chip (SoC) can still perform the same functions according to the contents stored in the non-volatile memory after power on.

Users can use the same type of System on Chip (SoC) to develop programs or data stored in non-volatile memory according to different requirements. If the program or data stored in non-volatile memory is acquired by others, they can copy the same function System on Chip (SoC) with the same program or data, which is unwilling to happen to users.

At present, there are many methods to protect, prevent penetrating or read out programs or data stored in non-volatile memory, which are limited to physical protection of the System on Chip (SoC) itself; if they are stolen from the original source of programs or data, all existing physical protection will be ineffective. Other methods, such as adding physical unclonable function (PUF) encryption protection design into the chip (e.g. Taiwan patent number 1488477), it requires special processes of manufacturing (e.g. Taiwan patent number 1571906), or special design (e.g. Taiwan patent application number 201734879).

In view of the shortcomings of the above-mentioned technology, the present invention provides a novel method for preventing non-volatile memory of the System on Chip (SoC) from being duplicated to overcome the above shortcomings.

### SUMMARY

The invention proposes a method for restrictedly and only writing random numbers in a specific address range of non-volatile memory of System on Chip (SoC). As a result, different System on Chip (SoC) will have differences in physical intrinsic property due to its different data in the specific address range, which will result in absolute physical barriers that cannot be completely replicated.

The writing method of the non-volatile memory is accomplished by the non-volatile memory controller of the invention, which can be realized by the logic circuit in the chip and must be designed to be completely uncontrollable by the program. The controller can automatically detect whether the write address is in a specific address range. If it falls within the range, the output of the random number generator is automatically selected as the write data. If it falls outside the range, it can be the same as the general non-volatile memory controller, and the write data signal of the system bus is selected as the write data.

A method for writing non-volatile memory of system-on-chip (SoC) comprises the following steps: inputting a write address signal to a write address logic device; determining the write address signal being a lower bound or an upper bound in a specific address range by the write address logic device to generate a selection code signal; inputting the selection code signal to a switching device to control a selection terminal of the switching device; inputting a write data signal of a random number generated by a random number generator to the selection terminal of the switching device; and inputting the write data signal of the random number to write in the specific address range of the non-volatile memory.

According to an aspect of the invention, a method for writing non-volatile memory of system-on-chip (SoC) is proposed which comprises the following steps: inputting a write address signal to a write address logic device; determining the write address signal being a lower bound or an upper bound in a specific address range by the write address logic device to generate a selection code signal; inputting said selection code signal to a switching device; inputting a first write data signal to a first terminal of the switching device, and inputting a second write data signal of a random number generated by a random number generator to a second terminal of the switching device; and based on a logical level of the selection code signal, selecting the second write data signal of the random number to write in a cell within the specific address range of the non-volatile memory, or selecting the first write data signal to write in a cell beyond the specific address range of the non-volatile memory.

The system-on-chip (SoC) includes a processing unit, a random number generator, a non-volatile memory control module, a non-volatile memory and a bus controller. The non-volatile memory control module is coupled with the non-volatile memory and the random number generator. The non-volatile memory control module includes the switching device, the write address logic device and a non-volatile memory controller.

The switching device includes a multiplexer including an input terminal, an output terminal and two selection terminals.

The write data in the specific address range cannot be controlled by a program.

### BRIEF DESCRIPTION OF THE DRAWINGS

The components, characteristics and advantages of the present invention may be understood by the detailed descriptions of the preferred embodiments outlined in the specification and the drawings attached:

FIG. 1 illustrates a schematic diagram of a non-volatile memory device according to one embodiment of the invention;

FIG. 2 illustrates a schematic diagram of a non-volatile memory control module according to one embodiment of the invention;

FIG. 3 illustrates a schematic diagram of a non-volatile memory control module according to another embodiment of the invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

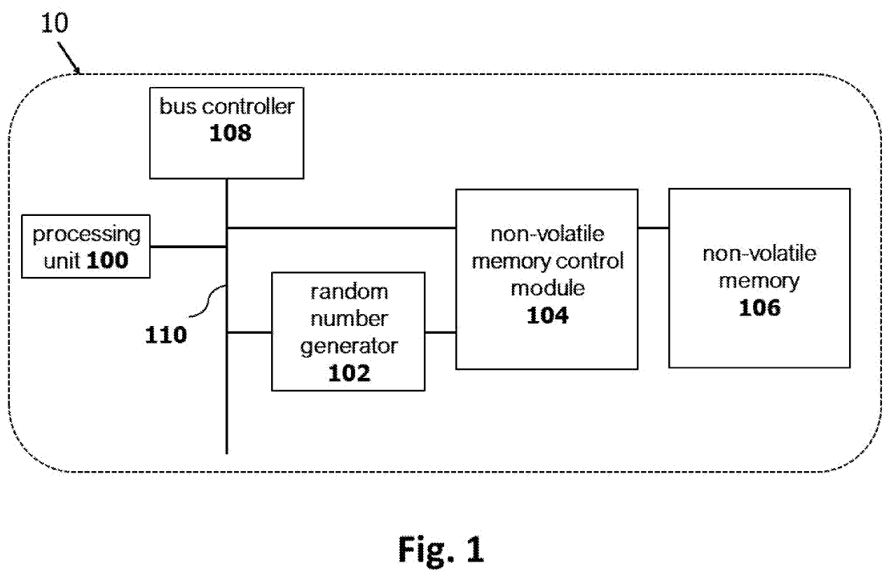

FIG. 1 illustrates a schematic diagram of a non-volatile memory device according to one embodiment of the invention. In this embodiment, the non-volatile memory device 10 is System on Chip (SoC), including a processing unit 100, a random number generator 102, a non-volatile memory control module 104, a non-volatile memory 106 and a bus controller 108. The non-volatile memory control module 104 is coupled with the non-volatile memory 106 and the random number generator 102. The non-volatile memory control module 104 can be implemented by a hardware or a firmware. For example, the non-volatile memory control module 104 is a logic circuit having multiple logic gates. By utilizing the non-volatile memory control module 104, data writing, reading, erasing, reorganizing and/or others operating in the non-volatile memory 106 can be performed according to instructions issued by a host or the processing unit 100. The processing unit 100, the random number generator 102 and the non-volatile memory control module 104 are combined via a bus 110 to form a non-volatile memory device 10 that can perform various signal processing.

The processing unit 100 is used to control the overall operation of the non-volatile memory control module 104. For example, the processing unit 100 may control the non-volatile memory control module 104 to execute the operation method of the present embodiment to reorganize the non-volatile memory 106 or to write data into the non-volatile memory 106. In an embodiment, the non-volatile memory control module 104 maintains information table or mapping table of one or more logical to physical address to record the mapping relationship of physical address for data in non-volatile memory 106. Thus, as the non-volatile memory 106 is accessing a logical address, the processing unit 100 can obtain the corresponding physical address according to the information table and access data on the physical address mentioned in the non-volatile memory 106.

In an embodiment, the non-volatile memory 106 includes one or more non-volatile memory modules, in which the number of the non-volatile memory modules depends on the application. For example, a non-volatile memory module has at least one physical block to store data written by the host or the processing unit 100. Each physical block has at least one page in which different pages belonging to the same physical block can be written independently and all pages belonging to the same physical block can be erased simultaneously. For example, each physical block can consist of 64, 128, 256 or any other number of pages. There are many kinds of non-volatile memory, such as flash memory, EPROM, EEPROM, MRAM, FRAM, and other memory with non-volatile property integrated into silicon wafer. Flash memory is for example single level cell (SLC) NAND flash memory, multi-level cell (MLC) NAND flash memory, triple level cell (TLC) NAND flash memory or other types of flash memory. Each cell of SLC NAND flash memory can store 1 bit of data, each cell of MLC NAND flash memory can store 2 bits of data, and each cell of TLC NAND flash memory can store 3 bits of data. SLC NAND flash memory has lower power consumption and better endurance, while MLC NAND flash memory has higher power consumption and lower endurance.

For multi-level cell and triple level cell NAND flash memory, they have the characteristics of Pair Page and multi-pages in the same cell, that is to say, one cell has corresponding bit data of two pages or three pages. In addition, for the same block, these pair pages may be continuous or discontinuous, depending on the design.

The random number generator 102 can be used to generate random numbers. The random number generator 102 is coupled with the non-volatile memory control module 104, so that the operation of the system on chip (SoC) of the above-mentioned non-volatile memory 106 is implemented. In the operation of the non-volatile memory control module 104, as the non-volatile memory 106 is performing an access, a specific address area of the non-volatile memory 106 is determined to perform a writing procedure for such area according to the random number generated by the random number generator 102.

Writing or reading data of the non-volatile memory 106 have their special control signals and timing, and the non-volatile memory 106 is not directly connected to the system bus 110. The non-volatile memory 106 is controlled by the corresponding non-volatile memory control module 104 such that the processing unit 100 can operate the non-volatile memory 106 through the system bus 110. In the present invention, writing process of the non-volatile memory 106 is accomplished by the non-volatile memory control module 104. In an embodiment, the non-volatile memory control module 104 can be implemented by a logic circuit in system on chip (SoC), and the non-volatile memory control module 104 must be designed to its write data within a specific address range that cannot be controlled by any program.

The non-volatile memory control module 104 can assign a specific address of the non-volatile memory 106 to be written into the signal generated by the random number generator 102. In other words, based on the non-volatile memory control module 104, the specific address range of the non-volatile memory 106 in system on chip (SoC) of the present invention will be restrictedly and only written into the random number generated by the random number generator 102. Because the random number generated for the specific address range is almost not identical for different system-on-chip (SoC), the data on non-volatile memory 106 cannot be completely replicated due to absolute physical obstacle. Therefore, the non-volatile memory 106 of the system-on-chip (SoC) of the present invention can prevent it from being completely copied by others system-on-chip (SoC).

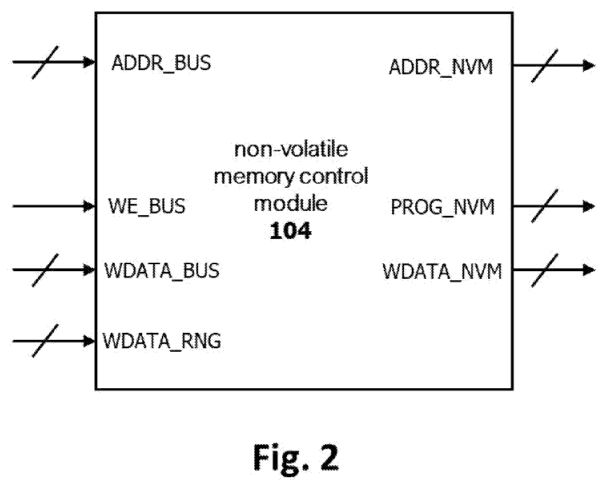

In the present invention, the non-volatile memory control module 104 is coupled with the non-volatile memory 106 and the random number generator 102. The nonvolatile memory control module 104 is connected to an output of the random number generator 102. As shown in the FIG. 2, the non-volatile memory control module 104 of the present invention can be fed with four types of input signals, namely, the address signal ADDR_BUS from the system bus 110, the write data signal WDATA_BUS from the system bus 110, the write control signal WE BUS from the system bus 110, and the signal WDATA_RNG from the random number generator 102. In an embodiment, the control signals and timing of the address signal ADDR_BUS, the write data signal WDATA_BUS, the write control signal WE BUS and the signal WDATA_RNG are issued by the processing unit 100 and controlled by the bus controller 108. Since the non-volatile memory control module 104 is connected to the output of the random number generator 102, the input signal of the non-volatile memory control module 104 includes the signal WDATA_RNG from the random number generator 102. That is to say, the input signal of the non-volatile memory control module 104 of the present invention includes not only the address signal ADDR_BUS from the system bus 110, the write data signal WDATA_BUS, and the write control signal WE BUS, but also the write data signal WDATA_RNG from the random number generator 102. In other words, in this embodiment, the architecture of the non-volatile memory control module 104 must be designed to receive the address signal ADDR_BUS, the write data signal WDATA_BUS, the write control signal WE BUS of the system bus 110, and the write data signal WDATA_RNG generated by the random number generator 102.

As shown in FIG. 2, in the control signal of the non-volatile memory control module 104, the address signal ADDR_BUS from the system bus 110 is directly mapped to the address signal ADDR NVM of the non-volatile memory 106, and the write data signal WDATA_BUS from the system bus 110 is directly mapped to the write data signal WDATA_NVM of the non-volatile memory 106, and the write control signal WDATA WE from the system bus 110 will trigger the state machine inside the non-volatile memory controller 120 to generate the whole write control signal PROG NVM of the non-volatile memory 106. In addition, by issuing instructions from the processing unit 100 and the control function of the non-volatile memory control module 104, the write data signal DATA RNG generated by the random number generator 102 can be selected and written in a memory cell within a specific address range of the nonvolatile memory 106.

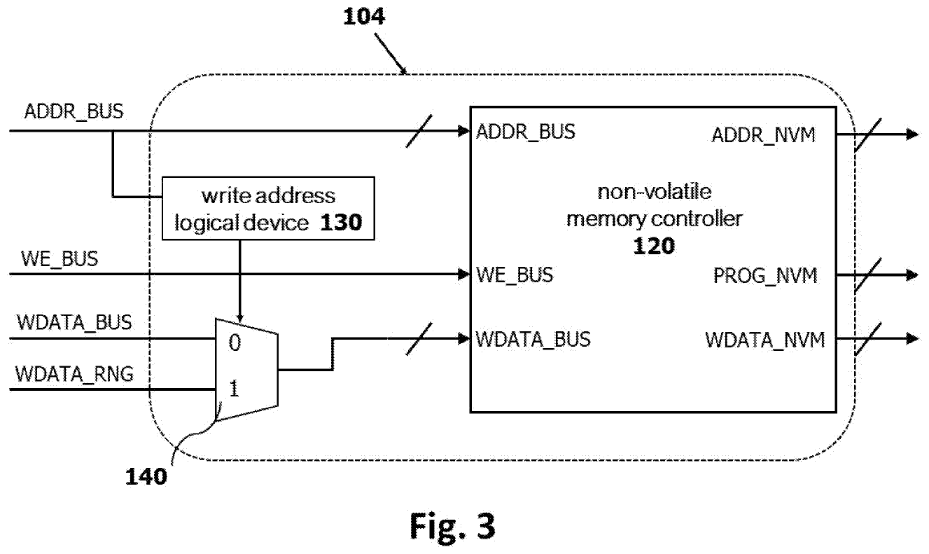

As shown in FIG. 3, in this embodiment, the non-volatile memory control module 104, which can be fed with signal of the system bus 100 and signal of the random number generator 102, includes a general non-volatile memory controller 120 which can be fed with three types of input signals of the the system bus 100, a write address logic device 130 and a switching device 140. The write address logic device 130 can judge that the input signal ADDR_BUS from the system bus 110 is the lower bound (RANGE LOW) or the upper bound (RANGE HIGH) of a specific address range to generate two selection codes, expressed as a digital signal 0 or 1. The lower bound (RANGE LOW) and the upper bound (RANGE HIGH) of the specific address range of the write address logic device 130 are constant. For example, in an embodiment, the switching device 140 includes multiple input ports, multiple multiplexers 140 and multiple select terminals, and each of the multiplexers 140 includes one input port, one output port and at least one selection terminal. In this embodiment, the multiplexer 140 has two select terminals to select write data signal WDATA_BUS or write data signal WDATA_RNG as write data signal of the non-volatile memory controller 120. Among the output signals of the general non-volatile memory controller 120, the address signal ADDR_BUS from the system bus 110 is directly mapped to the address signal ADDR NVM of the non-volatile memory 106, the write data signal WDATA_BUS from the system bus 110 is directly mapped to the write data signal WDATA_NVM of the non-volatile memory 106, and the write control signal WDATA WE from the system bus 110 triggers the state machine inside the non-volatile memory controller 120 to generate the write control signal PROG NVM of the whole non-volatile memory 106. However, in this embodiment, due to the addition of the write address logic device (write address judgment logic) 130 and the multiplexer 140 in the architecture of the non-volatile memory control module 104 and feeding signal of the random number generator 102, the procedure of writing data signal WDATA_NVM for the non-volatile memory 106 in the non-volatile memory control module 104 will be different from the procedure of writing data signal WDATA_NVM for the non-volatile memory 106 in the non-volatile memory controller 120.

As shown in FIG. 3, in the non-volatile memory control module 104, the procedure of writing data signal WDATA_BUS of the system bus 110 includes: the write address signal ADDR_BUS of the system bus 110 is input to the write address logic device 130; then, the write address logic device 130 determines that the address signal ADDR_BUS is a lower bound RANGE LOW or an upper bound RANGE HIGH in a specific address range according to the input write address signal ADDR_BUS to generate a selection code signal, which is expressed as a digital signal 0 or 1. Next, the selection code generated by the judgment result is input to the multiplexer 140 of the switching device to control the multiplexer 140 to choose the write data signal, that is, to input the write data signal in one selection terminal of the multiplexer 140. For example, when the selection code of the judgment result is 0, the multiplexer 140 chooses the write data signal WDATA_BUS, and when the selection code of the judgment result is 1, the multiplexer 140 chooses the write data signal WDATA_RNG, as the write data signal of the non-volatile memory controller 120.

As noted above-mentioned, the non-volatile memory controller 120 can automatically detect whether the input address signal ADDR_BUS of the system bus 110 is within a specific address range; if the write address falls within the range, the output write data signal WDATA_RNG of the random number generator 102 is automatically selected to be as the write data, and if the write address falls outside the range, identical with the general non-volatile memory controller 120, the write data signal WDATA_BUS of the system bus 110 is selected as the write data.

In the present invention, the non-volatile memory 106 can be programmed to store the selection codes of each write address logic device 130. Based on the selection codes, each multiplexer 140 can be controlled to select the actual input signal to the non-volatile memory controller 120 by controlling the selection terminal of each multiplexer 140 to act as the write data signal (WDATA_BUS) of the non-volatile memory controller 120.

In the present invention, a relatively large specific address range of the non-volatile memory 106 can be designed, and the random number generator 102 with relatively good source characteristics of random number can be selected, so that the probability of data duplication within the specific address range can be reduced to a negligible level.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A method for writing non-volatile memory of system-on-chip (SoC), comprising:
inputting a write address signal to a write address logic device;
determining said write address signal being a lower bound or an upper bound in a specific address range by said write address logic device to generate a selection code signal;
inputting said selection code signal to a switching device to control a selection terminal of said switching device;
inputting a write data signal of a random number generated by a random number generator to said selection terminal of said switching device; and
inputting said write data signal of said random number to write in said specific address range of said non-volatile memory.

2. The method of claim 1, wherein said system-on-chip (SoC) includes a processing unit, a random number generator, a non-volatile memory control module, a non-volatile memory and a bus controller.

3. The method of claim 2, wherein said non-volatile memory control module is coupled with said non-volatile memory and said random number generator.

4. The method of claim 3, wherein said non-volatile memory control module includes said switching device, said write address logic device and a non-volatile memory controller.

5. The method of claim 1, wherein said switching device includes a multiplexer.

6. The method of claim 5, wherein said multiplexer includes an input terminal, an output terminal and two selection terminals.

7. The method of claim 1, wherein said write data in said specific address range can not be controlled by a program.

8. The method of claim 1, wherein said lower bound and said upper bound in said specific address range are constant.

9. The method of claim 1, wherein said non-volatile memory includes single level cell (SLC) NAND flash memory, multi-level cell (MLC) NAND flash memory, or triple level cell (TLC) NAND flash memory.

10. The method of claim 1, wherein said non-volatile memory includes flash memory, EPROM, EEPROM, MRAM, FRAM, and other memory with non-volatile property integrated into silicon wafer.

11. A method for writing non-volatile memory of system-on-chip (SoC), comprising:
inputting a write address signal to a write address logic device;
determining said write address signal being a lower bound or an upper bound in a specific address range by said write address logic device to generate a selection code signal;
inputting said selection code signal to a switching device;
inputting a first write data signal to a first terminal of said switching device, and inputting a second write data signal of a random number generated by a random number generator to a second terminal of said switching device; and
based on a logical level of said selection code signal, selecting said second write data signal of said random number to write in a cell within said specific address range of said non-volatile memory, or selecting said first write data signal to write in a cell beyond said specific address range of said non-volatile memory.

12. The method of claim 11, wherein said system-on-chip (SoC) includes a processing unit, a random number generator, a non-volatile memory control module, a non-volatile memory and a bus controller.

13. The method of claim 12, wherein said non-volatile memory control module is coupled with said non-volatile memory and said random number generator.

14. The method of claim 13, wherein said non-volatile memory control module includes said switching device, said write address logic device and a non-volatile memory controller.

15. The method of claim 11, wherein said switching device includes a multiplexer.

16. The method of claim 15, wherein said multiplexer includes an input terminal, an output terminal and two selection terminals.

17. The method of claim 11, wherein said write data in said specific address range can not be controlled by a program.

18. The method of claim 11, wherein said lower bound and said upper bound in said specific address range are constant.

19. The method of claim 11, wherein said non-volatile memory includes single level cell (SLC) NAND flash memory, multi-level cell (MLC) NAND flash memory, or triple level cell (TLC) NAND flash memory.

20. The method of claim 11, wherein said non-volatile memory includes flash memory, EPROM, EEPROM, MRAM, FRAM, and other memory with non-volatile property integrated into silicon wafer.
